(19) United States
(12) Patent Application Publication
(10) Pub. No.: US 2009/0166110 A1
(43) Pub. Date: Jul. 2, 2009

(54) MATERIAL HANDLING VEHICLE INCLUDING INTEGRATED HYDROGEN STORAGE

(76) Inventors: Bryce A. Gregory, Binghamton, NY (US); Steve Medwin, Binghamton, NY (US); Brian Bordwell, Greene, NY (US); Mike Field, Lansing, NY (US); James E. Banko, II, Susquehanna, PA (US)

Correspondence Address: QUARLES & BRADY LLP, 411 E. WISCONSIN AVENUE, SUITE 2040, MILWAUKEE, WI, 53202-4497, US

(21) Appl. No.: 12/340,932

(22) Filed: Dec. 22, 2008

Related U.S. Application Data
(60) Provisional application No. 61/017,286, filed on Dec. 28, 2007.

(51) Int. Cl. B60L 11/18; B60K 15/073

(52) U.S. Cl. 180/65.31; 180/312

(57) ABSTRACT

A material handling vehicle incorporating integrated hydrogen storage is disclosed. The vehicle comprises a tank configured to contain hydrogen and a fuel cell coupled to the tank for receiving hydrogen from the tank and converting the hydrogen to an electric current. In various embodiments, a mast for manipulating a load, an overhead guard covering an operator area, and/or a chassis comprise a tank configured to contain hydrogen. The tank may be coupled to, integral with, and/or within the mast, overhead guard, and/or chassis and may contain a solid hydrogen carrier, gaseous hydrogen, and or liquid hydrogen.

### CROSS-REFERENCE TO RELATED APPLICATIONS

This application claims priority to U.S. provisional application No. 61/017,286 filed Dec. 28, 2007, which is hereby incorporated by reference as if fully set forth herein.

### STATEMENT REGARDING FEDERALLY SPONSORED RESEARCH OR DEVELOPMENT

Not applicable.

### FIELD OF THE INVENTION

The invention relates to a material handling vehicle, and more particularly, to a material handling vehicle configured to contain hydrogen for operation with a hydrogen fuel cell power system.

### BACKGROUND OF THE INVENTION

Material handling vehicles, for example, fork trucks, pallet trucks, order pickers, and the like, are routinely used in various industries to move nearly all types of product. Many of these vehicles incorporate electric power systems, which offer certain advantages because they can be recharged using available electric power supplies. Electric power systems, however, have several drawbacks. Recharging and replacing batteries, for example, is time consuming and requires specialized equipment, which can both increase the vehicle downtime and overall cost of operating the vehicle.

Hydrogen fuel cell power systems have been incorporated into vehicles in an effort to eliminate the inefficiencies of the typical electric power system that draws power only from onboard batteries. In a hydrogen fuel cell power system, hydrogen stored onboard of the vehicle is routed to multiple fuel cells in a fuel cell stack where the hydrogen is manipulated to create an electric current. The electric current is used to charge onboard batteries and power other electronic components. Simplistically, fuel cells use hydrogen and oxygen to create an electric current by separating electrons from hydrogen molecules and routing the electrons through an electrical circuit. The electron deficient hydrogen molecules are then recombined with the electrons and oxygen molecules to form water. The creation of an electric current onboard by the fuel cell eliminates long battery recharge time and the need routinely to manipulate bulky batteries. Thus, hydrogen fuel cell power systems reduce or eliminate many of the drawbacks of conventional electric power systems.

Storing ample hydrogen for the fuel cell on the material handling vehicle, however, presents a practical problem. In comparing typical gasoline and hydrogen systems, when gaseous hydrogen is pressurized to 5,000 pounds per square inch, twelve times more volume is required to store the equivalent amount of energy found in conventional gasoline. Increasing the storage pressure of hydrogen to 10,000 pounds per square inch reduces the volumetric ratio to a still significant eight to one. As a result, storing a sufficient amount of hydrogen onboard the vehicle to meet or exceed the operating parameters of fossil-fuel based systems presents a significant impediment to the design and widespread adoption of hydrogen fuel cell systems.

Previous inventions have attempted to retrofit fuel cell assemblies, including hydrogen storage tanks or pressure vessels, into the preexisting battery compartment space. In these vehicles, however, the mass of the retrofit fuel cell assembly is typically significantly less than the mass of the battery it is replacing—undesirably altering the vehicle dynamics. Furthermore, because the battery compartment space is relatively small, the amount of work that a vehicle can perform before needing to refill the hydrogen storage (i.e., duty cycle) is inadequate for many applications, especially as compared to traditional power systems.

In light of the above, a need exists for a material handling vehicle having onboard hydrogen storage that increases the hydrogen storage capacity without significantly altering the dynamics of the material handling vehicle.

### BRIEF SUMMARY OF THE INVENTION

The present invention addresses all of the above needs, and more, with material handling vehicles that maximize the space within and around the vehicle for the storage of hydrogen. The material handling vehicles in accordance with the invention incorporate hydrogen storage with the mast, overhead guard, and/or chassis, where applicable. The present invention makes the use of hydrogen fuel cell powered vehicles practical by, among others, extending the vehicle duty cycle, maintaining operator visibility, and preserving vehicle dynamics. It is of note that the invention is equally applicable to hybrid power systems wherein hydrogen storage needs are present in addition to more traditional fuels such as propane.

In one embodiment, the present invention includes a material handling vehicle having a mast for manipulating a load. The mast comprises a tank configured to contain hydrogen. A fuel cell is coupled to the tank for receiving hydrogen from the tank and converting the stored hydrogen to an electric current.

In another embodiment, the invention includes a material handling vehicle comprising an overhead guard. The overhead guard includes a tank configured to contain hydrogen. A fuel cell is coupled to the tank for receiving hydrogen from the tank and converting the hydrogen to an electric current.

In yet another embodiment, the present invention includes a material handling vehicle comprising a chassis having a tank configured to contain hydrogen. A fuel cell is coupled to the tank for receiving hydrogen from the tank and converting the hydrogen to an electric current.

The foregoing and other advantages of the invention will appear from the following description. In the description, reference is made to the accompanying drawings that form a part hereof and in which there is shown, by way of illustration, example embodiments of the invention. These example embodiments, however, do not necessarily represent the full scope of the invention and reference must be made to the claims for determining the scope of the invention.

### BRIEF DESCRIPTION OF THE DRAWINGS

FIG. 1 is a side elevation view of a material handling vehicle in accordance with an example embodiment of the present invention;

FIG. 2 is a top view of the material handling vehicle of FIG. 1;

FIG. 3 is a partial side view of a tank coupled to the mast assembly of FIG. 1;

FIG. 4 is a partial side view of a mast assembly including hydrogen storage;

FIG. 5 is a partial cross-section of the mast of FIG. 4 showing the member of the mast assembly defining a tank;

FIG. 6 is a partial isometric view of various mast member cross-sections in accordance with the present invention;

FIG. 7 is a partial cross-section of the mast of FIG. 4 showing multiple tanks housed within members of the mast assembly;

FIG. 8 is a partial cross-section of an alternative mast showing the member of the mast assembly defining a tank and housing multiple tanks;

FIG. 9 is a partial cross-section of an overhead guard of FIG. 1 showing multiple tanks coupled to the overhead guard;

FIG. 10 is a partial cross-section of an overhead guard of FIG. 1 showing the overhead guard defining a tank;

FIG. 11 is a partial cross-section of an overhead guard of FIG. 1 showing the overhead guard housing a tank;

FIG. 12 is a side view of a chassis of FIG. 1;

FIG. 13 is a top view of the chassis of FIG. 12;

FIG. 14 is a cross-section of the chassis of FIG. 12 showing the chassis defining a tank;

FIG. 15 is a cross-section of the chassis of FIG. 12 showing a tank housed within the chassis;

FIG. 16 is an isometric view of a second material handling vehicle in accordance with the present invention;

FIG. 17 is a partial isometric view showing the chassis of FIG. 16 housing multiple tanks;

FIG. 18 is a top view showing the chassis of FIG. 16 defining tanks;

FIG. 19 is a partial isometric view showing an alternative example embodiment of the present invention;

FIG. 20 is a partial isometric view of an alternative tank configuration;

FIG. 21 is a partial side view of the tank configuration of FIG. 20; and

FIG. 22 is a top view of the tank configuration of FIG. 20.

### DETAILED DESCRIPTION OF THE PREFERRED EMBODIMENT

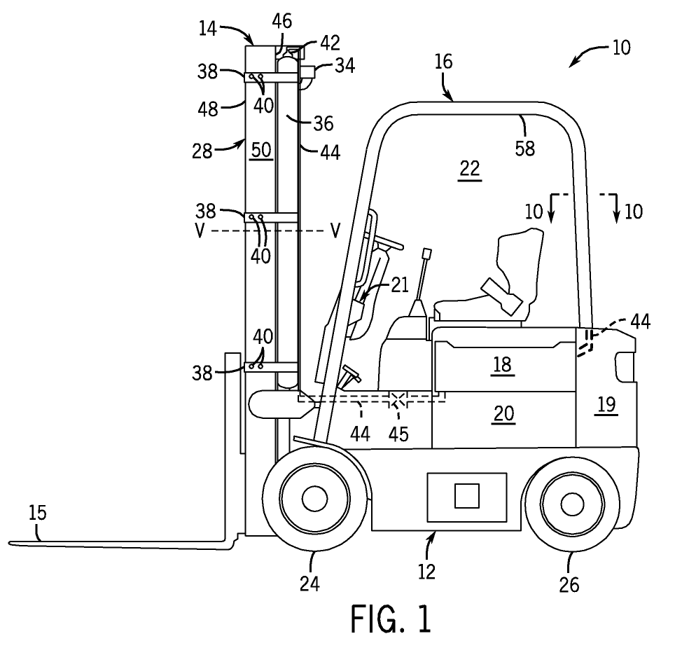

The present invention is applicable to all material handling vehicles and industrial trucks including, but not limited to, fork trucks, order pickers, pallet trucks, tow tractors, stackers, swing reach/turret trucks, sideloaders, and counterbalanced trucks; however, the example embodiment will be described with specific reference to the forklift truck 10 shown in FIG. 1. Additionally, gaseous hydrogen is the preferable form of hydrogen for indoor use because it does not vent any boil off (i.e., unused hydrogen) into the surrounding atmosphere, unlike typical liquid hydrogen. However, when the application finds use outside of an enclosed environment, liquid hydrogen may be used.

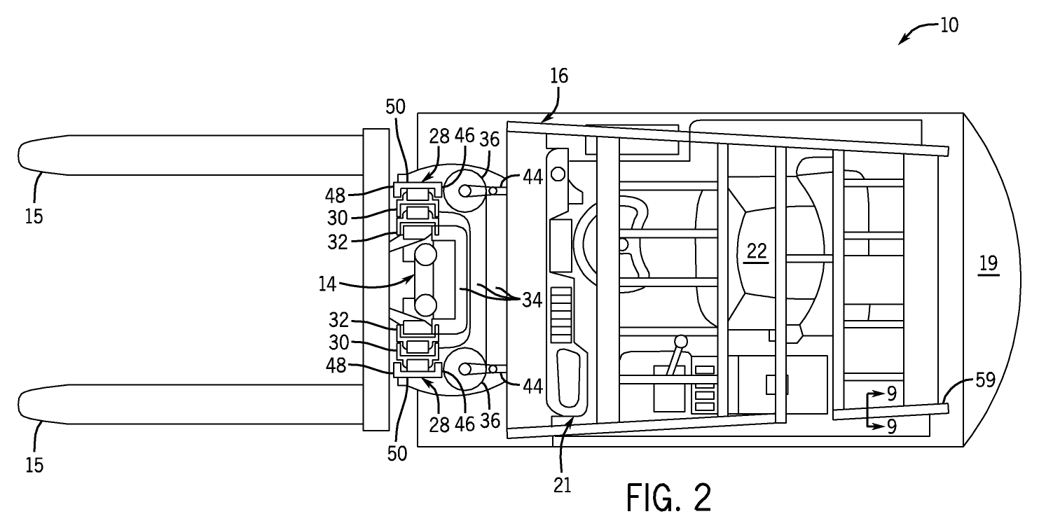

Referring to FIGS. 1 and 2, several main components combine to create a forklift truck 10. A chassis 12 establishes a framework and shell in which a fuel cell 18 and battery 20 are housed, and to which a mast assembly 14 and overhead guard 16 are attached. The mast assembly 14 is connected at the forward end of the forklift truck 10 and is used to manipulate a load with forks 15 extending forward from the mast assembly 14. The overhead guard 16 extends above and around the operator area 22 and is designed to protect the operator while working within the operator area 22. A pair of drive wheels 24 is located near the forward end of the forklift truck 10 and a pair of steering wheels 26 is located near the rearward end of the forklift truck 10. A counterbalance mass 19 is incorporated at the rear of the forklift truck 10 and is configured to counteract the moment created by a load placed on the forks 15, thus ensuring that the dynamics of the forklift truck 10 remain under control at all times, even when the mast assembly 14 is fully extended.

Hydrogen is stored onboard of the forklift truck 10 in a pressure vessel or tank and is coupled to the fuel cell 18 to create an electric current. The electric current created by the fuel cell 18 is typically coupled to the battery 20 where the charge is stored until needed to operate the forklift truck 10 (e.g., propel the drive wheels 24, raise the mast assembly 14, power operator instrumentation 21, and the like). The general components and operation of a hydrogen fuel cell forklift truck 10 are well known to those skilled in the art. Therefore, the remaining description focuses on the new and useful hydrogen storage of the present invention.

Hydrogen may be stored in liquid form, gas form, combined with a solid hydrogen carrier, or some combination thereof. In dealing with material handling vehicles, e.g., a forklift truck 10, the two general categories of high mass and low mass storage systems must be considered so as to maintain and/or improve the dynamics of the material handling vehicle.

High mass systems incorporate materials such as steel tanks or solid hydrogen carriers (e.g., metal hydrides and the like). Due to the substantial mass added by these systems, each application requires specific analysis to determine the strategic placement of the tank and associated components to optimize each material handling vehicle.

Low mass systems include the use of lighter tank materials, such as, composite tanks, small diameter stainless steel tubing (typically less than three inches in nominal diameter), or liquid tanks. As opposed to high mass systems, low mass systems and tanks do not require significant alteration of a material handling vehicle because the dynamic effects of the low mass system are minimal. However, given the particular placement and capacity of the low mass system, the dynamics of the material handling vehicle may require application specific analysis to keep a material handling vehicle's center of gravity low, maintaining the desired stability of the vehicle.

The center of gravity of a material handling vehicle, regardless of incorporation of a high mass or low mass system, is preferably maintained low and centered within the vehicle. Altering the distribution of mass of a material handling vehicle with low, centered, vertically hung stationary masses requires less dynamic consideration than symmetric lateral and fore/aft alterations to the same vehicle. Further, any asymmetric alterations that affect the center of gravity of a material handling vehicle (especially on high-lift trucks wherein the load being manipulated may be suspended a significant distance from the main body of the material handling vehicle) require a more in-depth review to ensure that the functionality and capabilities of the material handling vehicle remain at desired levels. Such lateral and fore/aft changes require consideration and evaluation on an application-by-application basis.

Although varying by application, in an exemplary embodiment, the weight of hydrogen stored in the various configurations is unlikely to exceed approximately eleven pounds; thus, the weight fluctuation as hydrogen is consumed during operation will have little influence on the overall center of gravity and dynamics of the material handling vehicle.

In accordance with the invention, a hydrogen tank may be configured with the mast 14, the overhead guard 16, and/or the chassis 12 of the forklift truck 10, collectively the “components.” In each configuration, the hydrogen tank(s) are operationally coupled to the fuel cell 18 and the tank(s) may be coupled to, integral with, and/or housed within, the various components (i.e., mast 14, overhead guard 16, and/or chassis 12). Many tank-component combinations exist. In one non-exhaustive example configuration, a first tank may be integral with the mast 14, a second tank may be coupled to the overhead guard 16, and a third tank may be housed within the chassis 12, all within one material handling vehicle. Any one of the tank-component combinations is within the scope of the present invention.

In one example embodiment, hydrogen storage may be provided in conjunction with the mast assembly 14. As more clearly shown in FIG. 2, the mast assembly 14 is typically comprised of a pair of base members 28, a pair of outer telescoping members 30, and a pair of inner telescoping members 32. Cross-ties 34 typically couple opposing members (e.g., the base members 28) to provide added rigidity to the overall mast assembly 14. The base members 28 are affixed to the chassis 12 and thus are not capable of extending vertically. The outer telescoping members 30 are nested within the base members 28 and are capable of extending vertically. The inner telescoping members 32 are further nested within the outer telescoping members 30 and are too capable of extending vertically.

The depicted mast assembly 14 represents only one of the numerous mast assemblies to which the present invention is applicable. For example, integrated masts (i.e., where the rams for actuating the mast are also structural members) and mono masts (i.e., where the masts consists of a single support mast) are viable alternative configurations.

As previously mentioned, hydrogen is stored in a tank 36 that can be configured with the mast assembly 14 in several ways. Generally, the tank 36 may be coupled to the mast assembly 14, integral with the mast assembly 14, and/or housed within the mast assembly 14. Each of the variations will be described below in turn.

With reference to FIGS. 1-3, a pair of tanks 36 are shown coupled to the mast assembly 14, specifically the base members 28. In the present example, the tanks 36 are placed on the rear face 46 of the mast assembly 14 to minimize the impediment to the operator's forward visibility. The tanks 36 may alternatively be placed on the front face 48 or side faces 50 of the mast assembly 14, provided the tanks 36 do not interfere with the operation of the mast assembly 14 or operator's visibility. If additional hydrogen storage is desired, a single tank 36 may extend between the base members 28. To prevent any obstruction to the operator's view, the single tank 36 may be constructed to only extend between the base members 28 at a height below line V-V as shown on FIG. 1. In any configuration, the placement of the tank 36 must be carefully considered to avoid obstructing the operator's view. For example, should the tanks 36 be placed adjacent the side faces 50, the tanks 36 may need to be secured lower than line V-V to ensure maximum operator visibility.

The tanks 36 may be coupled adjacent the mast assembly 14 in various ways. For example, the tanks 36 of the example embodiment are coupled to the base members 28 with straps 38 secured to the base members 28 with bolts 40. Other coupling mechanisms, such as ratchet straps, are available to secure the tanks 36 to the mast assembly 14 during operation of the forklift truck 10. In general, the dynamic nature of the tanks 36 must be taken into consideration, in addition to the typical lack of suspension on material handling vehicles, when designing the coupling system for each tank 36. Any straps, bands, brackets, adhesives, welds, pins/hinges, and/or foam encasements should allow for some freedom for expansion and contraction, bending, and torsion of the materials and tanks 36 without fatiguing the coupling. Isolation mounts (not shown) or other absorption materials may be included to reduce the vibrations transferred to or between tanks 36. Additional considerations for environmental effects should be incorporated. For example, a material handling vehicle that routinely operates in and out of a freezer requires couplings that allow for cyclical expansion and contraction of components.

The tanks 36 are preferably coupled to the base member 28 of the mast assembly 14 because the base members 28 are stationary and do not extend and retract during operation of the forklift truck 10. However, with the appropriate couplings between tanks 36, tanks 36 may be secured to other or multiple members of the mast assembly 14, such as the outer telescoping member 30 and the inner telescoping member 32. Additional center of gravity benefits are achieved by keeping the tank 36 mass substantially at or below the collapsed height of the forklift truck 10. Securing tanks 36 to the upper members (e.g., the outer telescoping member 30 and the inner telescoping member 32) of the mast assembly 14 raises the center of gravity of the forklift truck 10 and requires that the counterbalance mass 19 increases accordingly, especially when a high mast or a high mass system is used.

The hydrogen within the tank 36 is expelled out of control valve 42 and through lines 44 where it preferably combines with a tank 36 coupled to the other base member 28 of the mast assembly 14. A pressure regulator 45 is placed in the lines 44 to maintain an appropriate pressure as the hydrogen flows to the fuel cell 18. The lines 44 are preferably hard-plumbed stainless steel lines, but may be flexible lines and the like. Alternatively, each tank 36 may be plumbed to a common rail (not shown) where the pressure of the hydrogen is regulated and monitored. While a single or multiple pressure regulators 45 may be placed anywhere along lines 44, the pressure regulator 45 is preferably placed downstream of the common rail at or near the location of the fuel cell 18. All of the various example embodiments are plumbed and coupled to the fuel cell 18 in a similar manner.

The specifics of hydrogen storage and delivery are well known to those having ordinary skill in the art. However, in regards to material handling vehicles, several items are of note due in part to the dynamic, unsuspended nature of most material handling vehicles and the small size of hydrogen molecules. Fittings should be avoided where possible in place of welded joints. Further, where fittings and joints are used, they should be located in areas that are easily checked for leakage and, should a leak occur, be vented to the atmosphere to prevent the buildup of hydrogen in a confined volume.

The tanks 36 in this example embodiment are typical pressure vessels used to store fluids (e.g., gases and liquids) under pressure. Typical tanks 36 are produced from steel, but may be of a lighter or heavier material to reduce or increase the amount of mass added to the mast assembly 14. The tanks 36 may be capable of being replaced by removing the straps 38 or the tanks may be refilled via control valve 42 or a separate hydrogen port (not shown) connected so as to allow all of the tanks 36 to be refilled from one convenient location. Additionally, the tank 36 need not extend the length of the mast assembly 14, several shorter tanks 36 may be attached to the mast assembly 14 and plumbed together using conventional techniques.

Tanks 36 may be cast, rolled, formed, and the like. The storage method desired, be it liquid, solid, or gas, and the size of the tank 36 will generally define the material the tank 36 is made of. A small diameter tube shaped tank 36 would generally be produced from stainless steel. When the liquid form of hydrogen is used, a substantial insulative layer must be included. Furthermore, despite that pressure vessels and tanks 36 are typically rounded, non-curved tanks 36 (e.g., square, rectangle, triangular, and the like) are possible given the appropriate design considerations (stresses, pressures, etc.), especially for relatively small tanks 36. Lastly, the stresses imparted by welding of small and relatively thin walled tanks 36 requires significant design consideration to ensure the proper operation of the tank 36.

Another way in which hydrogen is stored in a tank configured with the mast assembly 14 requires that the tanks be integral with the members of the mast assembly 14. In this scenario, the members of the mast assembly 14 define the tanks 36 and thus directly store the hydrogen. The tanks 36 are designed taking into account the traditional requirements of pressure vessels, in addition to ensuring the proper clearances for expansion and contraction of the pressurized portion of the tank 36 to allow the forklift truck 10 to operate as desired.

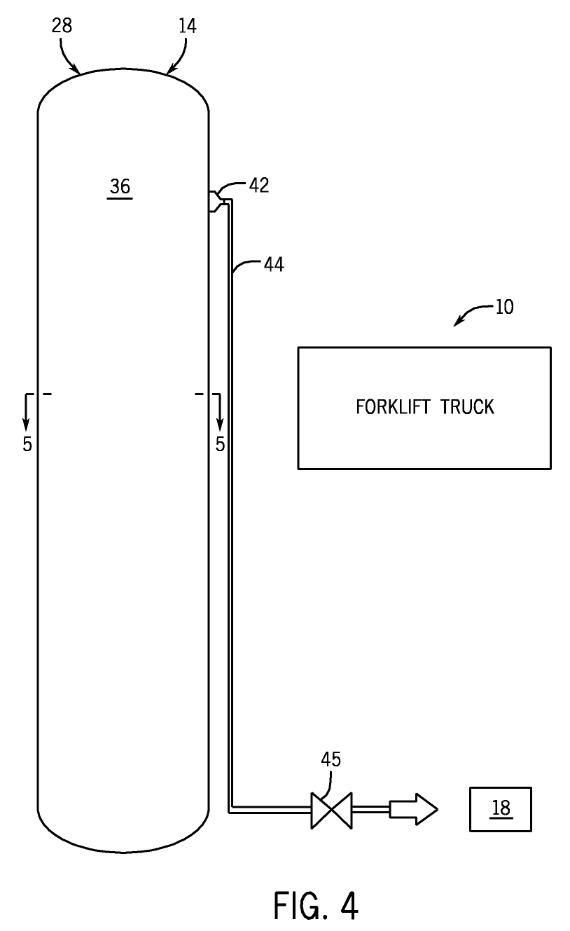

Turning briefly to FIG. 4, a simplified representation of a member of the mast assembly 14 is shown. For simplicity, the base member 28 is shown as the only member with integrated hydrogen storage; however, with the appropriate coupling between the base member 28 and the telescoping members (i.e., outer telescoping member 30, inner telescoping member 32), all of the members of the mast assembly 14 may be configured as tanks 36 similar to the base member 28. A high mass system used as a section in the mast assembly 14 of a forklift truck 10 can be configured to have a mass substantially similar to the non-hydrogen storing counterpart, thus maintaining the predefined dynamics of the forklift truck 10. Again, however, any significant change in mass would require reevaluation.

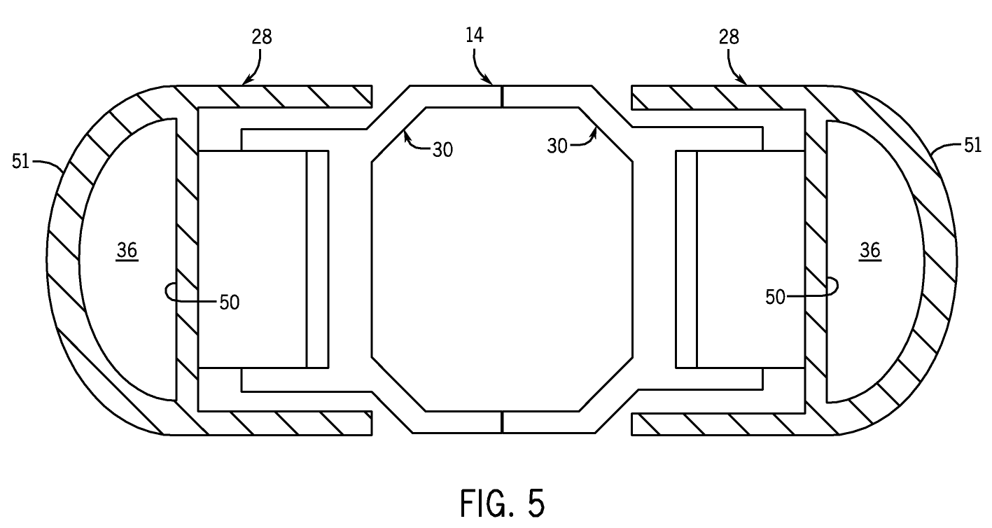

Turning to FIG. 5, a partial cross section of the base members 28 illustrates a pair of tanks 36 defined by the base members 28. In this example embodiment, the hydrogen (in any form, e.g., gas, liquid, solid) is stored within the tanks 36 as defined by the base members 28. Each tank 36 is defined by the side face 50 of the base member and an arcuate wall 51 extending therefrom. As a result, the structural integrity of the base members 28 remains intact. In the example embodiment, the depth of the tank 36 may be between approximately eight and nine inches. A ten-foot long base member 28 could store approximately forty liters, thus two base members 28 could store approximately 1.8 kilograms of hydrogen at a pressure of approximately 5000 pounds per square inch, a substantial amount of hydrogen. While the example embodiment illustrates a single tank 36 extending the length of the base member 28, multiple tanks 36 may be defined along the length of the base member 28 in longitudinal compartments.

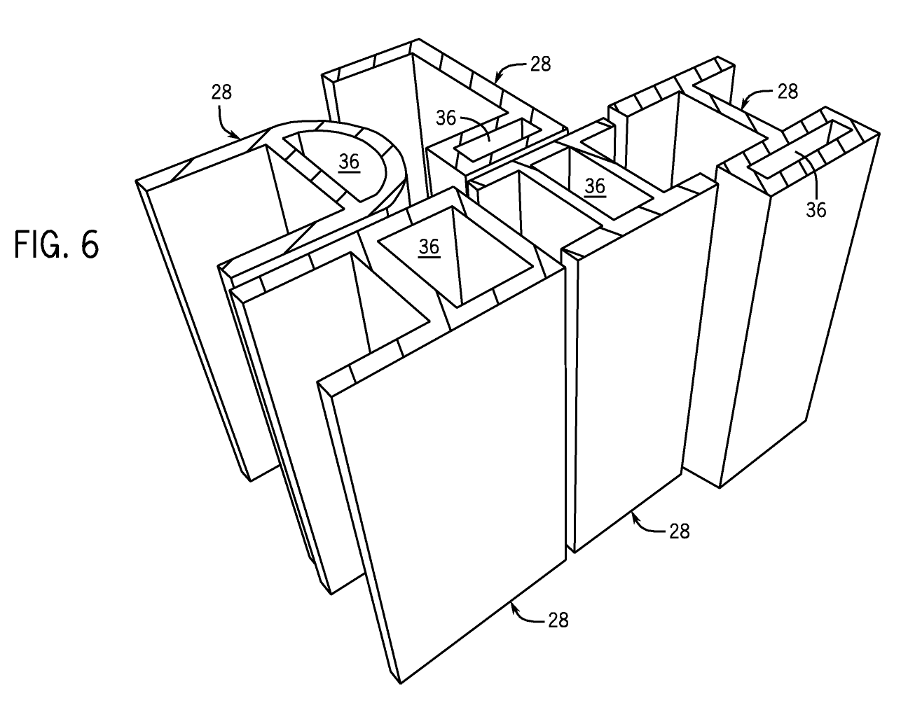

Several of the available mast assembly 14 member cross-sections (e.g., base member 28) are illustrated in FIG. 6. Each mast assembly 14 member defines a tank 36 that may be used to store hydrogen in accordance with the present invention. In addition to the mast assembly 14 members, the cross-ties 34 (shown in FIG. 2) may be configured to store hydrogen and be coupled to an overall hydrogen storage system.

Application requirements, vehicle dynamics, and pressure vessel design are considered to create a particular tank 36. For example, only the lower portion of the base member 28 may be configured as a tank 36 where the vehicle dynamics dictate a lower center of gravity. The materials and dimensions are influenced by such factors as the required internal pressure of the tank 36 and susceptibility of the tank 36 to vibration. Additionally, if the tank 36 needs to be replaced, ease of removal from the mast assembly 14 should be considered.

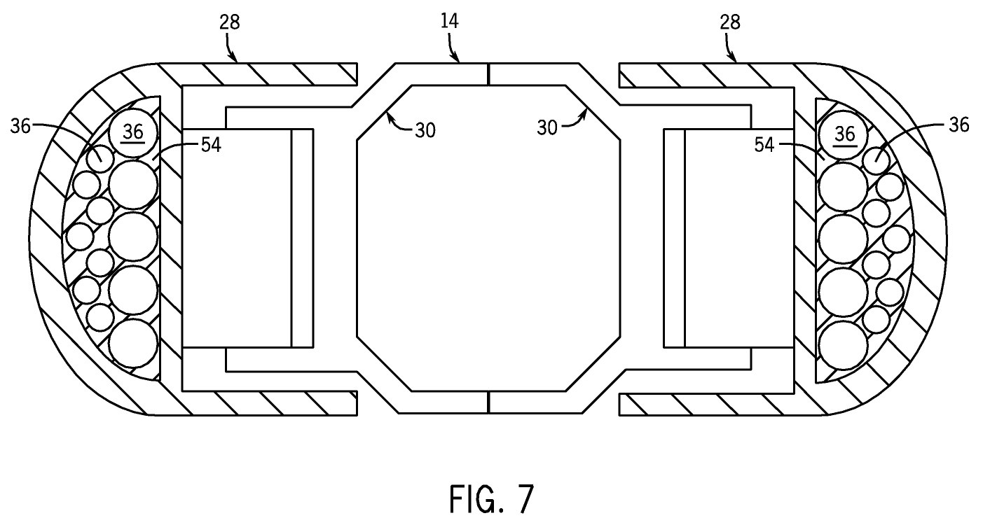

In yet a further example, the tank 36 may be housed within the mast assembly 14. Turning to FIG. 7, the base member 28 is shown housing multiple tanks 36. The tanks 36 are secured within the base member 28 and coupled to the fuel cell 18 by conventional means. For example, the tanks 36 may be encased in a foam material that provides both vibration dampening and thermal insulation for the tanks 36. Again, similar structures are possible for housing tanks 36 within the outer telescoping members 30 and/or inner telescoping members 32 given the appropriate tank 36 connections.

Ballast 54 may be included to at least partially surround the tanks 36. The ballast 54 may be an insulative material such as a polymer, rubber, foam, and the like, insulating the tanks 36 from vibration, shock, and the ambient environment. Where liquid hydrogen is stored in the tanks 36, the ballast 54 may include the appropriate insulation to maintain the desired storage parameters.

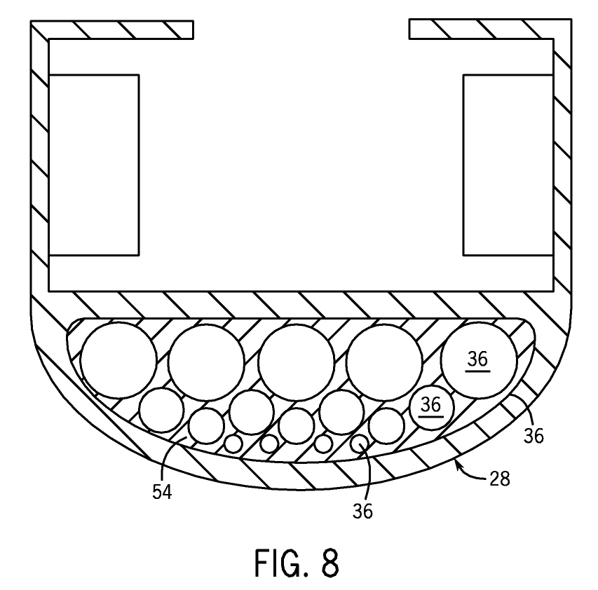

Turning briefly to FIG. 8, a variation of the base member 28 is illustrated. The base member 28 defines a tank 36, houses multiple tanks 36, and includes a ballast 54. The main tank 36 extends between the left and right extremes of the base members 28. The tanks 36 housed within the main tank 36 are at least partially surrounded by ballast 54. To maximize hydrogen storage, the ballast 54 may comprise a solid hydrogen carrier and be plumbed with the other tanks 36. However, if added insulation is desired, the ballast 54 may comprise an insulative material.

Each of these hydrogen storage techniques may be combined to obtain the most efficient result given the specifics of the application. Certain configurations may be preferred where additional ballast 54 is required due to the dynamics of the forklift truck 10. For example, only the lower portion of the base member 28 of the mast assembly 14 may contain ballast 54 comprising concrete, steel shot, and the like to keep the forklift truck 10 center of gravity low.

We turn our attention to a second example embodiment of the present invention in which hydrogen is stored in conjunction with the overhead guard 16 shown in FIGS. 1 and 2. All of the above considerations (e.g., plumbing configuration, tank materials, vehicle dynamics, and the like) are equally applicable to the second example embodiment. With this in mind, it is possible to configure the overhead guard 16 similar to the members of the mast assembly 14. As with the mast assembly 14, the tank of the overhead guard 16 may be coupled to the overhead guard 16, integral with the overhead guard 16, and/or housed within the overhead guard 16.

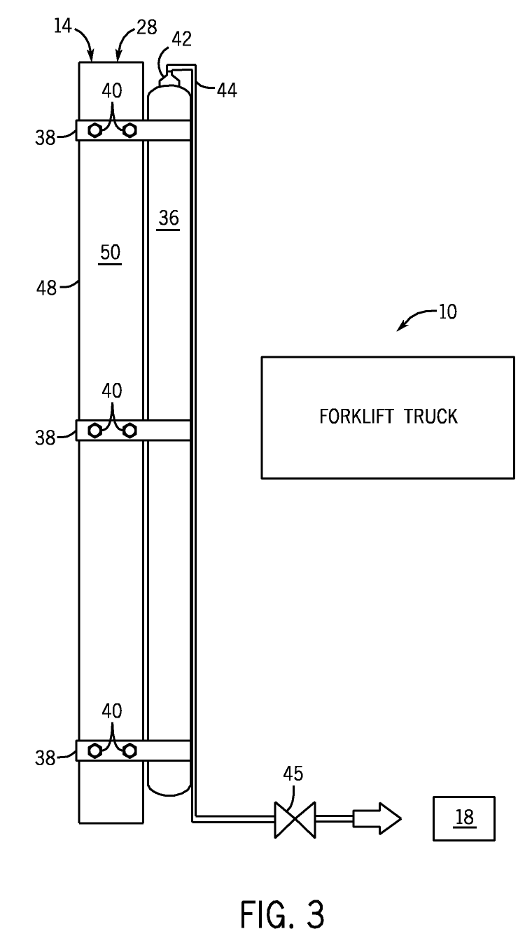

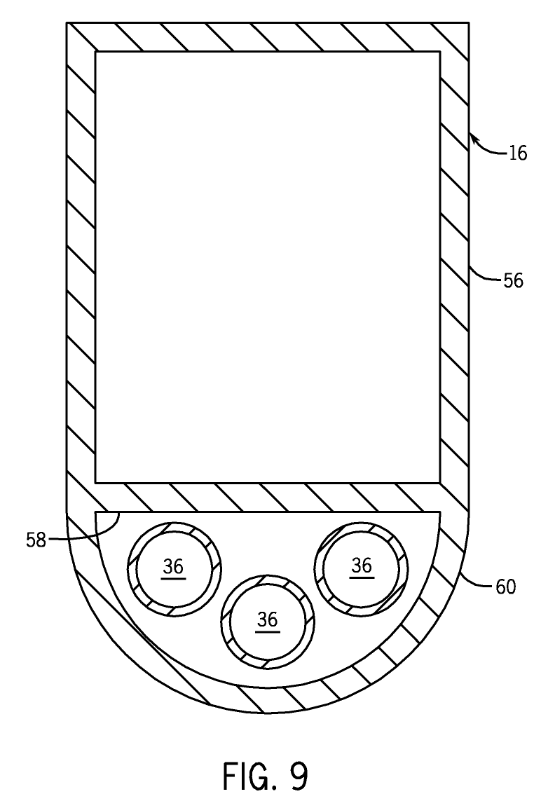

With reference to FIGS. 2 and 9, a possible implementation of hydrogen storage coupled to the overhead guard 16 is described. A guard member 56 with an adjacent bundle of tanks 36 is illustrated in FIG. 9. It is preferable in the overhead guard 16 configuration that the tanks 36 be near the underside 58 or inside 59 of the overhead guard 16 to insulate the hydrogen within the tanks 36 from falling objects or other stresses imparted to the overhead guard 16. Additionally, note that the tanks 36 are preferably housed beneath a shell 60 extending from the underside 58 of the guard member 56. Alternatively, the tanks 36 may be secured to the overhead guard 16 in a manner similar to the tanks 36 shown attached to the base member 28 in FIG. 3.

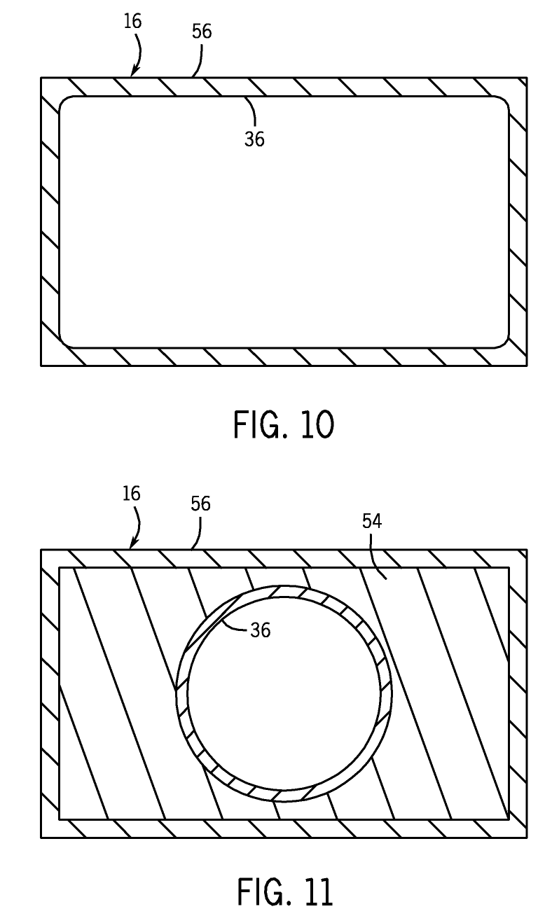

However, turning to FIG. 10, the guard member 56 of the overhead guard 16 can also be constructed to define the tank 36. Or, as illustrated in FIG. 11, a tank 36 may be housed within the guard member 56 and may include a ballast 54 comprising an insulative material, a counterweight, a solid hydrogen carrier, and the like.

Referring again to FIG. 1, lines 44 may be run from the various tanks 36 of the overhead guard 16 into the fuel cell 18 by means well known to those of ordinary skill in the art. As with the tanks 36 incorporated with the mast assembly 14, the tanks 36 of the overhead guard 16 may be of varying constructions and may be plumbed in such a manner to allow efficient regulating and refueling.

Configuring tanks 36 in the overhead guard 16 creates additional forklift truck 10 dynamic considerations. By adding mass to the overhead guard 16, the center of gravity of the forklift truck 10 is raised, lessening the stability of the forklift truck 10. To help compensate, ballast 54 may be added to the lower portions of the overhead guard 16 (or another portion of the forklift truck 10) or low mass systems principles may be used (e.g., composite tanks) in the overhead guard 16. In one example, the ballast 54 may comprise a solid hydrogen carrier configured to supply hydrogen to the fuel cell 18.

A third example embodiment of the present invention includes hydrogen storage configured with the chassis 12. Again, all of the above considerations (e.g., plumbing configuration, tank materials, vehicle dynamics, and the like) are equally applicable to the third example embodiment wherein the chassis 12 forms the basis for hydrogen storage.

As with the mast assembly 14 and the overhead guard 16, the tank of the chassis 12 may be coupled to the chassis 12, integral with the chassis 12, and/or housed within the chassis 12. The term “chassis” is used broadly to encompass, at a minimum, the members making up the frame of the vehicle (here a forklift truck 10) and the structure surrounding an operator area.

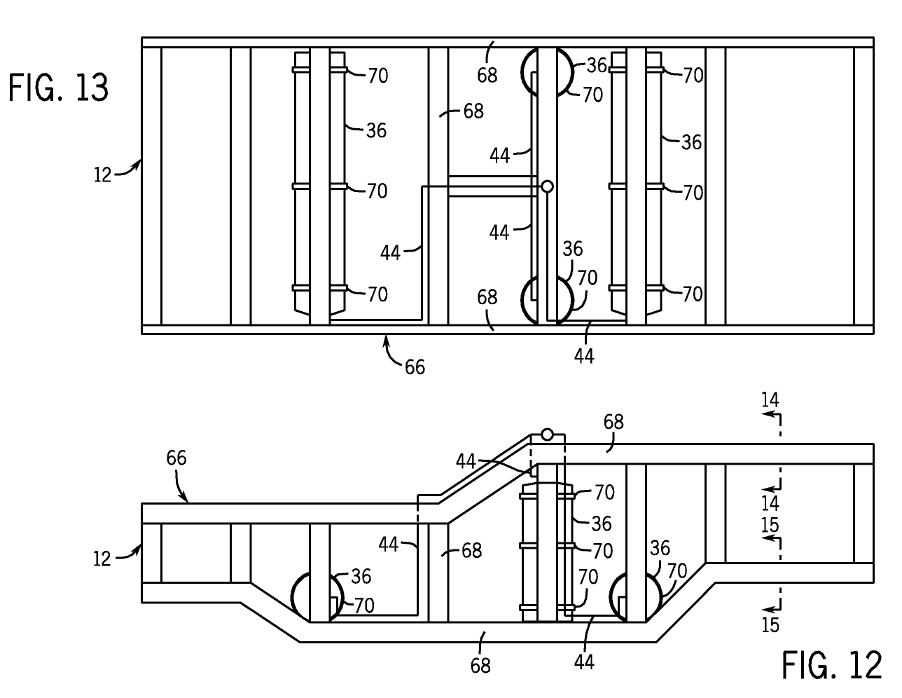

Turning to FIGS. 12 and 13, an example of tanks 36 integrated with the chassis 12 of the forklift truck 10 is shown. An example frame 66 is illustrated with several tanks 36 coupled to the frame 66 in various locations. The tanks 36 are secured to the frame 66 by straps 70 or any other suitable means discussed above. The tanks 36 of this example include pressure vessels sized to accommodate the particular application. Two tanks 36 are mounted horizontally to the frame 66 along horizontally oriented frame members 68 and two tanks 36 are mounted vertically along vertically oriented frame members 68. The tanks 36 are plumbed together and to the fuel cell 18 by lines 44. The lines 44 are preferably routed along the frame members 68 to provide mounting support. As with the previous examples, the flow of hydrogen may include pressure regulators, a common rail, control solenoids, and other components, well known to those having ordinary skill, required for the delivery and control of hydrogen.

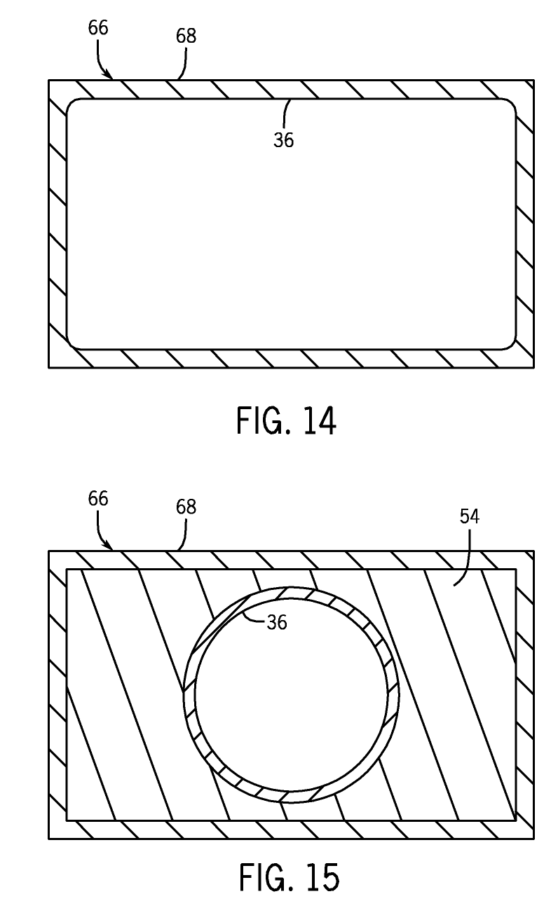

The tank 36 may be integral with the chassis 12 as shown in FIG. 14. FIG. 14 is a cross section of a frame member 68 of the frame 66. Again, the chassis 12 is constructed to define the tank 36. In this embodiment, the frame member 68 is strengthened to accommodate the internal pressures applied by the stored hydrogen and the traditional stresses imparted on the frame 66 of a forklift truck 10. Other features, such as rounded internal corners, are incorporated to reduce stress concentrations inherent in traditional frame forming and construction.

Turning to FIG. 15, the frame member 68 is shown having a tank 36 housed within. This is the preferred method of hydrogen storage in the chassis 12 because the ballast 54 may comprise an insulative material and the strength of the chassis 12 is maintained. For example, the ballast 54 may include a polymer configured to encase the tank 36, thus providing additional resistance to shock and vibration during operation of the forklift truck 10. Many other materials may be incorporated in combination or individually, including, but not limited to, rubber, foam, and the like. Furthermore, the ballast 54 may also comprise a solid hydrogen carrier when the frame member 68 defines the tank 36.

The tanks 36, as described in relation to any embodiment, are preferably made of 316L stainless steel and may of varying dimensions. Table A lists some of the possible tank 36 dimensions and approximate hydrogen storage capacities when the tank 36 takes the general form of a tube.

TABLE A
Round Tubing

| | | | | | Length |
|---|---|---|---|---|---|
| | | | Cross | | For 1 kg |
| Wall | | | Sectional | | H₂ @ |
| thick | O.D. | I.D. | Area | Volume | 5000 psi |
| (in) | (in) | (in) | (in²) | (l/ft) | (ft) |
| 0.095 | 0.500 | 0.310 | 0.08 | 0.01 | 2897 |
| 0.095 | 0.625 | 0.435 | 0.15 | 0.03 | 1471 |
| 0.109 | 0.75 | 0.532 | 0.22 | 0.04 | 948 |
| 0.113 | 1.05 | 0.824 | 0.53 | 0.10 | 410 |
| 0.133 | 1.315 | 1.049 | 0.86 | 0.17 | 253 |

Table B lists some of the possible tank 36 dimensions and approximate hydrogen storage capacities when the tank 36 takes the general form of a rectangle or square, more typically found in the chassis 12 or overhead guard 16.

TABLE B
Rectangular Tubing

| | | | | | | Hydrogen |
|---|---|---|---|---|---|---|
| | | | Wall | | Total | Capacity @ |
| | | | Thickness | Volume | Volume | 5000 psi |
| W (in) | H (in) | L (in) | (in) | (l/in) | (l) | (kg) |
| 4 | 4 | 40 | 0.375 | 0.17 | 6.92 | 0.16 |
| 2 | 4 | 40 | 0.375 | 0.07 | 2.66 | 0.06 |
| 4 | 4 | 40 | 0.25 | 0.20 | 8.03 | 0.19 |
| 2 | 2 | 40 | 0.25 | 0.04 | 1.47 | 0.03 |

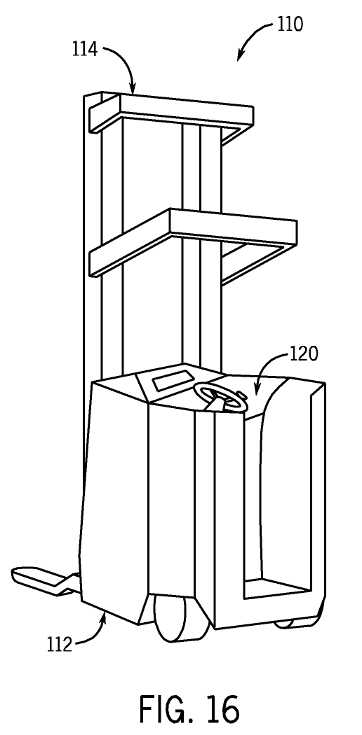

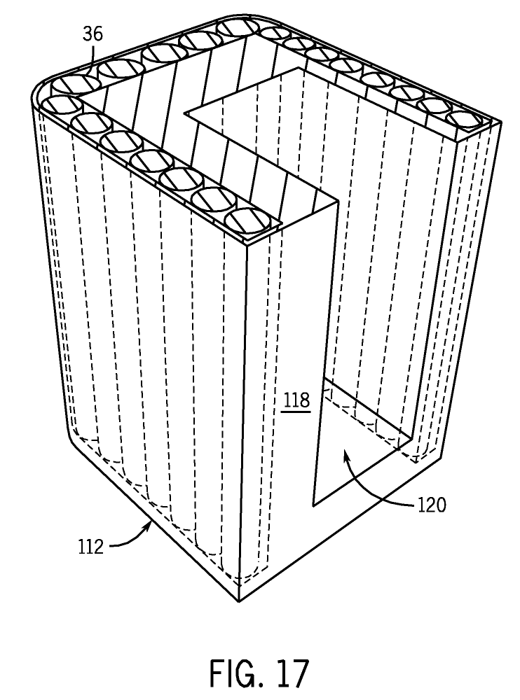

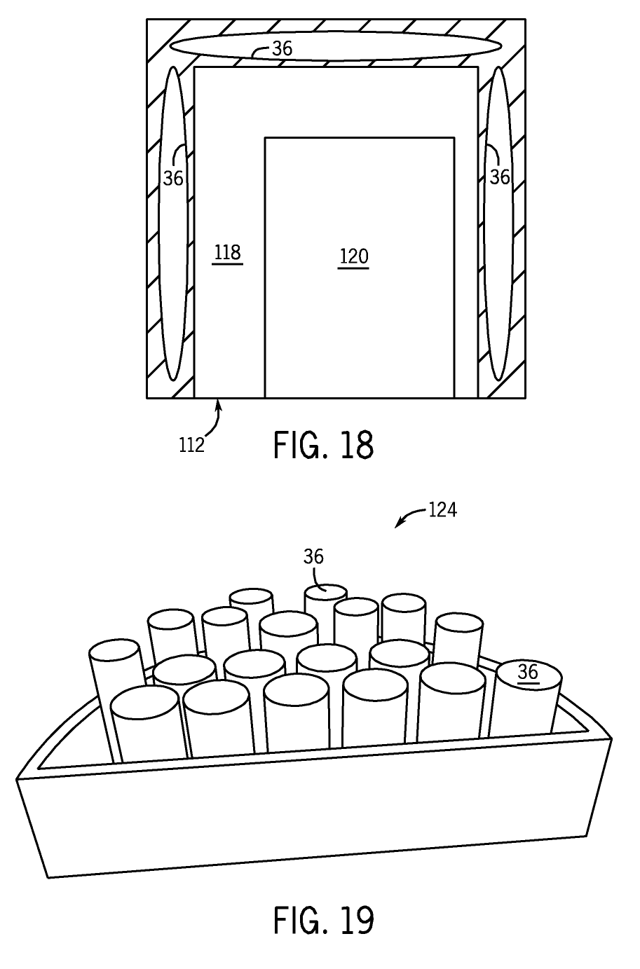

Turning to FIGS. 16-18, another material handling vehicle 110 incorporating an exemplary embodiment of the present invention is illustrated. The vehicle 110 includes a chassis 112 supporting a mast assembly 114 and defining an operator area 120. Tanks 36 are housed within the chassis 112 around the operator area 120. Preferably, multiple individual tanks 36 are plumbed together to flow to the fuel cell 118. This configuration allows standard pressure vessels to be housed within the chassis 112 with little or no additional modification. With reference to FIG. 18, and as with the previous example embodiments, the chassis 112 could define the tanks 36. Furthermore, the chassis 112 need not form a single tank 36, but instead may define multiple tanks 36 encased in foam 122 or some other ballast as shown in FIG. 18.

An example assembly 124 of tanks 36 is shown in FIG. 19. The tanks 36 are of two different sizes to better maximize the amount of hydrogen storage volume available. Table C provides a summary of the example assembly 124 and the approximate hydrogen storage capacity. Approximately 15 feet of tubing, given the configuration disclosed, is required to store 1 kilogram of hydrogen at 5,000 pounds per square inch.

TABLE C
Example Assembly

| Diameter of | Number of | Volume |
|---|---|---|
| Tubes | Tubes | (l/ft) |
| 1″ ID | 11 | 1.782134 |
| 0.75″ ID | 8 | 1.018098 |
| Totals | 19 | 2.800232 |

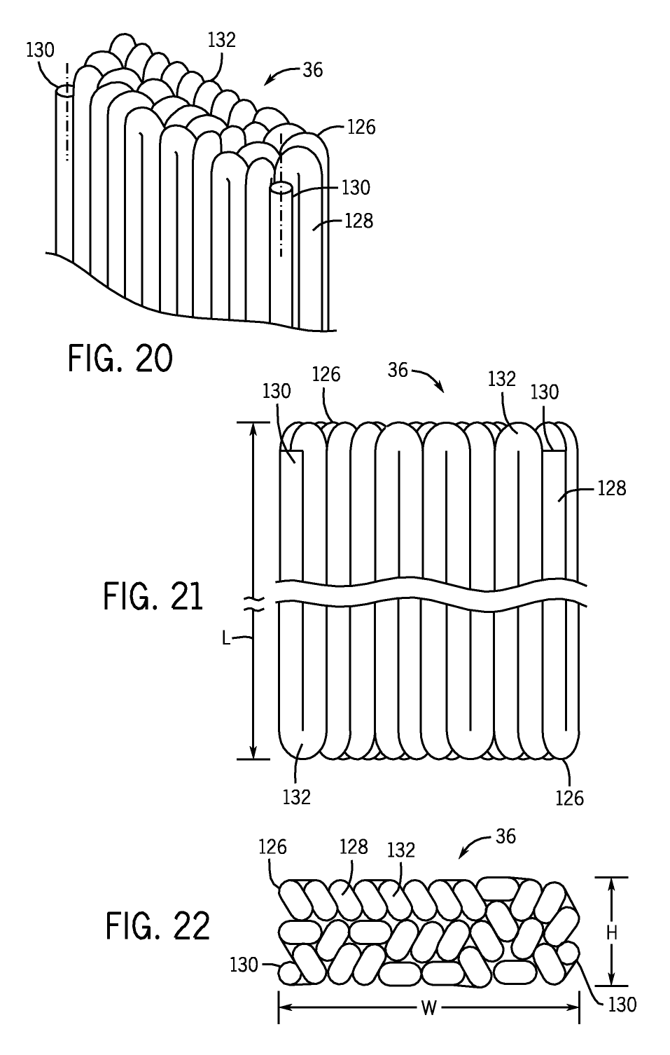

With additional reference to FIGS. 20-22, an alternative configuration for the tank 36 is depicted. The tank 36 shown is comprised of a single continuous and substantially uniform diameter tube 128 that is formed, such as by bending, into a compact configuration to maximize the capacity of the tank 36 given an available design envelope. Tubes of varying or distinct cross-section may be incorporated such that the tank 36 contours to the design envelop into which the tank 36 is to occupy. For example, the tube 128 may have one portion defining a larger cross-section that tapers to define a smaller cross-section. Moreover, smaller diameter tubes allow for smaller bending radii, thus allowing for increasingly configurable designs. The tubes of varying diameter may be coupled in an end-to-end fashion or in a manifold-type arrangement that provides various pathways (or a single pathway) within the tank 36.

The tank 36 configuration may be designed to fit within, couple to, or form integrally with at least one member of the mast assembly 14, the overhead guard 16, and/or the chassis 12. The compact arrangement of the tubing 128 increases the mass of the tank 36 and thus reduces the need for additional ballast, however, ballast may be incorporated if a particular application will benefit. In one preferred form, the length L (shown in FIG. 21) of the outer envelope of the tank 36 is greater than the width W and the height H (shown in FIG. 22), for example, to allow the tank 36 to fit within the mast assembly 14 or within/along a member of the frame 66. As shown, the tube 128 includes a plurality of repeating bends 132 between the ends 130 of the tube 128. However, the tubing 128 need not extend the full length L relative to each bend 132; alternatively, the tube 128 may include portions having a non-uniform length L.

Given the benefit of this disclosure, one skilled in the art will appreciate the many tube 128 configurations available in light of specific application requirements. For example, with reference to FIG. 22, the tube 128 may define a non-rectangular outer perimeter to accommodate particular limitations of the structure the tank 36 is intended to couple to or fit within.

Table D lists example tube 128 dimensions and tank 36 capacities when the tank 36 is configured generally as shown in FIGS. 20-22 and includes tubes 128 having two distinct diameters that are coupled together to form the tank 36.

TABLE D
Alternative Tank Configuration

| | | | | | | Length |
|---|---|---|---|---|---|---|
| | | | | | | For 1 kg |
| Wall | | | Cross | | | H₂ @ |
| thick | O.D. | I.D. | Sectional Area | Number of | Volume | 5000 psi |
| (in) | (in) | (in) | (in²) | Tubes | (l/ft) | (ft) |
| 0.113 | 1.050 | 0.824 | 0.53 | 8 | 0.838913 | |
| 0.133 | 1.315 | 1.049 | 0.86 | 11 | 1.869459 | |
| | | | | Total | 2.708372 | 15.88 |

Preferred example embodiments of the present invention have been described in considerable detail. Many modifications and variations of the preferred embodiment described will be apparent to a person of ordinary skill in the art. Therefore, the invention should not be limited to the embodiments described.

We claim:

1. A material handling vehicle, comprising:
a chassis;
a plurality of wheels coupled to the chassis;
a mast coupled to the chassis and including a fork moveably coupled to the mast for manipulating a load, the mast comprising a tank configured to contain hydrogen; and
a fuel cell coupled to the tank for receiving hydrogen from the tank and converting the hydrogen to an electric current for powering the vehicle to drive at least one of the plurality of wheels.

2. The material handling vehicle of claim 1, wherein the tank is integral with the mast.

3. The material handling vehicle of claim 1, wherein the tank is housed substantially within the mast.

4. The material handling vehicle of claim 3, wherein the tank is at least partially surrounded by a ballast.

5. The material handling vehicle of claim 1, wherein the tank is coupled to the mast.

6. The material handling vehicle of claim 1, wherein the tank comprises a substantially continuous tube having at least one bend positioned between ends of the tube.

7. The material handling vehicle of claim 6, wherein the tube defines a substantially uniform cross-section.

8. A material handling vehicle, comprising:
a chassis;
a plurality of wheels coupled to the chassis;
an overhead guard coupled to the chassis and covering an operator area, the overhead guard comprising a tank configured to contain hydrogen; and
a fuel cell coupled to the tank for receiving hydrogen from the tank and converting the hydrogen to an electric current for powering the vehicle to drive at least one of the plurality of wheels.

9. The material handling vehicle of claim 8, wherein the tank is integral with the overhead guard.

10. The material handling vehicle of claim 8, wherein the tank is housed substantially within the overhead guard.

11. The material handling vehicle of claim 10, wherein the tank is at least partially surrounded by a ballast.

12. The material handling vehicle of claim 8, wherein the tank is coupled to the overhead guard.

13. The material handling vehicle of claim 8, wherein the tank comprises a substantially continuous tube having at least one bend positioned between ends of the tube.

14. The material handling vehicle of claim 13, wherein the tube defines a substantially uniform cross-section.

15. An industrial truck, comprising:
a chassis, the chassis comprising a tank configured to contain hydrogen;
a plurality of wheels coupled to the chassis; and
a fuel cell coupled to the tank for receiving hydrogen from the tank and converting the hydrogen to an electric current for powering the truck to drive at least one of the plurality of wheels.

16. The industrial truck of claim 15, wherein the tank is integral with the chassis.

17. The industrial truck of claim 15, wherein the tank is housed substantially within the chassis.

18. The industrial truck of claim 15, wherein the tank is coupled to the chassis.

19. The industrial truck of claim 15, wherein the tank comprises a substantially continuous tube having at least one bend positioned between ends of the tube.

20. The industrial truck of claim 19, wherein the tube defines a substantially uniform cross-section.
